(19) United States
(12) Patent Application Publication
(10) Pub. No.: US 2019/0359919 A1
(43) Pub. Date: Nov. 28, 2019

(54) EFFERVESCENT BEVERAGES THAT FLUORESCE UNDER ULTRAVIOLET LIGHT AND METHODS OF PRODUCING SAME

(71) Applicant: Globier Inc., San Diego, CA (US)

(72) Inventors: Imad AJJAWI, San Diego, CA (US); Joshua M. SHAFFER, San Diego, CA (US)

(21) Appl. No.: 16/484,951

(22) PCT Filed: Feb. 9, 2018
(86) PCT No.: PCT/US2018/017598

§ 371 Date: Aug. 9, 2019

Related U.S. Application Data
(60) Provisional application No. 62/457,364, filed on Feb. 10, 2017.
(60) Provisional application No. 62/504,382, filed on May 10, 2017.

(51) Int. Cl. C12C 5/04; C12C 5/02; C12C 7/20; C12C 11/00; C12C 11/11

(52) U.S. Cl. CPC C12C 5/04; C12C 5/023; C12C 11/11; C12C 11/003; C12C 7/20

(57) ABSTRACT

Provided herein is an effervescent beer containing 0.005-0.17 mg/ml riboflavin such that the beer fluoresces upon exposure to light having an emission spectrum of about 100-500 nm. The riboflavin may be added alone or in combination with one or more additional agents to enhance the flavor, intensity and/or color of the light. Methods of producing such beers are also provided.

### CROSS REFERENCE TO RELATED APPLICATION(S)

This application claims the benefit of priority under 35 U.S.C. § 119(e) of U.S. Ser. No. 62/457,364, filed Feb. 10, 2017, and of U.S. Ser. No. 62/504,382, filed May 10, 2017, the entire content of each of which is incorporated herein by reference.

### BACKGROUND OF THE INVENTION

### Field of the Invention

The invention relates generally to making effervescent liquids glow in the dark and more specifically to making beer glow in the dark by addition of one or more agents and exposing the resulting beverage to black light.

### Background Information

As is well known and accepted in the malt beverage brewing art, subjecting a hopped, especially alcoholic, malt brewery beverage, such as lager; ale, porter, stout and the like, (herein generically referred to as “beer”), to sunlight or artificial light, results in a significant deleterious effect on the sensory qualities of the beverage by generating the so-called “skunky” flavor which is sometimes also referred to as “sunstruck” or “light struck” flavor. Some years ago, a group of researchers studied the formation of lightstruck flavor in beer (Chem. Eur. J. 2001, 4554). They found that isohumulones, compounds contributing to the bitter taste of beer, decomposed when exposed to ultraviolet light. The researchers (J. Agric. Food Chem, 2006, 6123) found that riboflavin (vitamin B2) acts as a photosensitizer in beer (and in olive oil, milk and butter) which catalyzes the conversion of oxygen to a more reactive type of oxygen (singlet oxygen). This oxygen then “destroys” isohumulone and in the process radicals are formed. Interestingly, humans are able to smell this compound at concentrations as low as a few parts per billion (ppb). The perhaps not-so-amazing thing is that this compound gives beer a “skunky” aroma. Obviously one would want to avoid this negative property, which is why many beers are sold in dark brown glass bottles.

While typical riboflavin levels of beer are in the range of 0.5-1.0 μM (or about 0.00025 to 0.00118 mg/ml), researchers have been studying ways to increase shelf life of bottled beer for many years (Duyvis, J. Agric. Food Chem., 2002, 50 (6), pp 1548-1552; see also, Tullo et al., (1945), Journal of the Institute of Brewing, 51: 86-96). Among the proposed methods include removing riboflavin from beer during the brewing process and/or prior to bottling (U.S. Pat. No. 5,582,857, incorporated herein by reference). Scientists at the Technical University of Dortmund designed a polymer “trap” with tiny crevices that capture the riboflavin molecules. Others have developed a protein treatment that binds riboflavin, resulting in a reduced lightstruck flavor formation after exposure of the beverage to light (see, EP0983340A1). Still others have investigated use of absorptive treatments, such as colloidal magnesium aluminum silicates, to remove riboflavin (see, U.S. Pat. No. 6,207,207, incorporated herein by reference).

The idea of making drinks glow in the dark for added visual appeal has been around for decades. U.S. Pat. No. 5,876,995 describes the potential use of luciferase to make beverages bioluminesce. US Pub. No. 2007/0292588 describes use of various synthetic dyes to make drinks fluoresce in different colors. As an April fool's joke the forum “homebrewtalk” described the use of quinine to make beer glow in the dark, while the website ThinkGeek.com pretended to sell beer that glows in the dark. More recently, the odin used a genetic engineering approach to express green fluorescent protein (GFP) in a French Saison yeast strain that could theoretically be used in a process to brew beer that glows in the dark, provided that the yeast doesn't precipitate and is not filtered away in the brewing process. Indeed, the idea of using GFP yeast to brew beer that glows in the dark has been around at least since 2012, as demonstrated by David Halvorsen's blog.

Despite years of interest in beverages that glow in the dark, a non-GMO beer made from natural ingredients that glows in the dark has not yet been described. Thus, a need exists for such effervescent drinks with a visual appearance that is attractive to customers.

### SUMMARY OF THE INVENTION

Provided herein is a safe, non-GMO method to make beer glow in the dark when exposed to UV (black) light. In various embodiments, riboflavin is used as the “glowing agent”.

Accordingly, the invention provides a fluorescent beer comprising 0.005-0.17 mg/ml of riboflavin content. In various embodiments, the beer has about 0.0125 mg/ml-0.033 mg/ml of riboflavin content, such as, for example, 0.0125 mg/ml-0.033 mg/ml of riboflavin content or 0.05 mg/ml to 0.13 mg/ml of riboflavin content. In various embodiments, the beer fluoresces when exposed to light having an emission spectrum of about 100-500 nm, for example, light having an emission spectrum of about 370-445nm. In various embodiments, the beer may also include one or more agents selected from the group consisting of vitamin A, thiamine (vitamin B1), vitamin B2, pyridoxine/pyridoxal phosphate (vitamin B6), niacin (vitamin B3), folate/folic acid (vitamin B9), vitamin B12, biotin (vitamin H), vitamin C, quinine, phycocyanin, and phycocyanobilin. In various embodiments, the beer may also include one or more bioluminescent compounds selected from the group consisting of green fluorescent protein, blue fluorescent protein, red fluorescent protein, and luciferase. In various embodiments, the beer may also include one or more flavoring agents selected from the group consisting of extract of passion fruit, extract of guava, extract of orange, extract of grape, extract of coconut, extract of citrus, extract of pineapple, extract of melon, extract of watermelon and extract of lemon. In various embodiments, the beer may also include honey, vanilla extract, coffee, bourbon, or maple syrup.

In another aspect, the invention provides a method for producing a fluorescent effervescent beverage. The method includes mixing a fluorescent agent with an effervescent beverage and exposing the mixture to a light having an emission spectrum of about 100-500 nm, thereby producing a fluorescent effervescent beverage. In various embodiments, the effervescent beverage is beer and the fluorescent agent is riboflavin. In various embodiments, the beverage is further mixed with one or more agents selected from the group consisting of vitamin A, thiamine (vitamin B1), vitamin B2, pyridoxine/pyridoxal phosphate (vitamin B6), niacin (vitamin B3), folate/folic acid (vitamin B9), vitamin B12, biotin (vitamin H), vitamin C, quinine, phycocyanin, and phycocyanobilin. In various embodiments, the beverage is further mixed with one or more bioluminescent compounds selected from the group consisting of green fluorescent protein, blue fluorescent protein, red fluorescent protein, and luciferase. In various embodiments, the effervescent beverage has about 0.0125 mg/ml-0.033 mg/ml of riboflavin content, such as, for example, 0.0125 mg/ml-0.033 mg/ml of riboflavin content. In various embodiments, the effervescent beverage fluoresces when exposed to light having an emission spectrum of about 100-500 nm, for example, light having an emission spectrum of about 370-445 nm. In various embodiments, the beverage is further mixed with one or more flavoring agents selected from the group consisting of honey, vanilla extract, coffee, bourbon, or maple syrup extract of passion fruit, extract of guava, extract of orange, extract of grape, extract of coconut, extract of citrus, extract of pineapple, extract of melon, extract of watermelon and extract of lemon.

In another aspect, the invention provides a method for producing a fluorescent beer. The method includes adding riboflavin to a wort of a beer brewing process; fermenting the mixture to produce ethanol and carbon dioxide from the wort; and producing a beer having about 0.005-0.17 mg/ml of riboflavin content. In various embodiments, the beer has about 0.0125 mg/ml-0.033 mg/ml of riboflavin content. In various embodiments, riboflavin in excess of 0.17 mg/ml is added to the wort before, during or after boiling of the wort. In various embodiments, the riboflavin is added before or after carbonation or nitrogenation of the beer. In various embodiments, the riboflavin is added in combination with one or more agents selected from the group consisting of vitamin A, thiamine (vitamin B1), vitamin B2, pyridoxine/pyridoxal phosphate (vitamin B6), niacin (vitamin B3), folate/folic acid (vitamin B9), vitamin B12, biotin (vitamin H), vitamin C, quinine, phycocyanin, and phycocyanobilin. In various embodiments, the riboflavin is added in combination with one or more bioluminescent compounds selected from the group consisting of green fluorescent protein, blue fluorescent protein, red fluorescent protein, and luciferase. In various embodiments, the riboflavin is added in combination with one or more flavoring agents selected from the group consisting of honey, vanilla extract, coffee, bourbon, or maple syrup extract of passion fruit, extract of guava, extract of orange, extract of grape, extract of coconut, extract of citrus, extract of pineapple, extract of melon, extract of watermelon and extract of lemon.

### BRIEF DESCRIPTION OF THE DRAWINGS

FIG. 1 is a pictorial diagram showing an exemplary brewing process.

FIG. 2 is a graphical diagram showing the absorption and fluorescence spectrum for riboflavin.

FIG. 3 is a graphical diagram showing the emission spectrum of a typical black light fluorescent tube.

FIG. 4 is a graphical diagram showing the absorption and emission spectra of quinine.

FIGS. 5A-5D are pictorial diagrams showing the appearance of 5% ethanol solutions supplemented with riboflavin under bright light (FIG. 5A) and black light (FIGS. 5B-5D). The UV light source was placed directly against the bottles (FIG. 5B), 3 feet away (FIG. 5C) and 8 feet away (FIG. 5D).

FIG. 6 is a pictorial diagram showing beer brewed with (left) and without (right) riboflavin. The beer supplemented with riboflavin glows bright yellow upon exposure to black light.

FIGS. 7A and 7B are pictorial diagrams showing the appearance of TECATE® light beer supplemented with a liquid solution of riboflavin, under bright light (FIG. 7A) and black light (FIG. 7B). As shown in FIGS. 7A and 7B, the beer on the left is the supplemented beer.

FIGS. 8A and 8B are pictorial diagrams showing a solution of pyridoxal phosphate (left) and pantothenic acid (right) exposed to bright light (FIG. 8A) and black light (FIG. 8B). The solution supplemented with 50 mg pyridoxal-5-phosphate glows when exposed to black light while the solution supplemented with 500 mg pantothenic acid does not.

FIG. 9 is a graphical diagram showing the absorption spectra of the active form of vitamin B6, pyridoxal-5-phosphate.

FIGS. 10A and 10B are graphical diagrams showing fluorescence in arbitrary units (A.U.) of TECATE® beer with and without addition of the solution supplementation when exposed to UV light at 374 nm (FIG. 10A) and 445 nm (FIG. 10B), as determined by measuring the emission at 524 nm on a SpectraMax M5 spectrophotometer (Molecular Devices).

### DETAILED DESCRIPTION OF THE INVENTION

The present invention is based on the observation that addition of riboflavin to an effervescent beverage results in a beverage that fluoresces upon exposure to ultraviolet light. The use of riboflavin has been previously described to make non-effervescent alcoholic drinks glow in the dark (see, WO2012/160402, incorporated herein by reference). However, use of riboflavin has not been described for beer or other non-effervescent drinks, which may be due to the fact that when riboflavin powder is added to a carbonated drink, it fizzes, sediments and sticks to the side of the container, thus losing the appeal to the consumer. Additionally, riboflavin is known to photo-oxidize, thereby deteriorating the flavor of various beers. As such, it is common to remove and/or filter riboflavin out of the beer prior to bottling and/or serving. Accordingly, the instant invention provides a method to circumvent these issues resulting in a clean beer that glows in the dark. Furthermore, the formulation was perfected to optimize for glow and taste, without jeopardizing its appearance in regular bright light.

Before the present compositions and methods are described, it is to be understood that this invention is not limited to particular compositions, methods, and experimental conditions described, as such compositions, methods, and conditions may vary. It is also to be understood that the terminology used herein is for purposes of describing particular embodiments only, and is not intended to be limiting, since the scope of the present invention will be limited only in the appended claims.

As used in this specification and the appended claims, the singular forms “a”, “an”, and “the” include plural references unless the context clearly dictates otherwise. Thus, for example, references to “the method” includes one or more methods, and/or steps of the type described herein which will become apparent to those persons skilled in the art upon reading this disclosure and so forth.

The term “comprising,” which is used interchangeably with “including,” “containing,” or “characterized by,” is inclusive or open-ended language and does not exclude additional, unrecited elements or method steps. The phrase “consisting of” excludes any element, step, or ingredient not specified in the claim. The phrase “consisting essentially of” limits the scope of a claim to the specified materials or steps and those that do not materially affect the basic and novel characteristics of the claimed invention. The present disclosure contemplates embodiments of the invention compositions and methods corresponding to the scope of each of these phrases. Thus, a composition or method comprising recited elements or steps contemplates particular embodiments in which the composition or method consists essentially of or consists of those elements or steps.

Unless defined otherwise, all technical and scientific terms used herein have the same meaning as commonly understood by one of ordinary skill in the art to which this invention belongs. Although any methods and materials similar or equivalent to those described herein can be used in the practice or testing of the invention, the preferred methods and materials are now described.

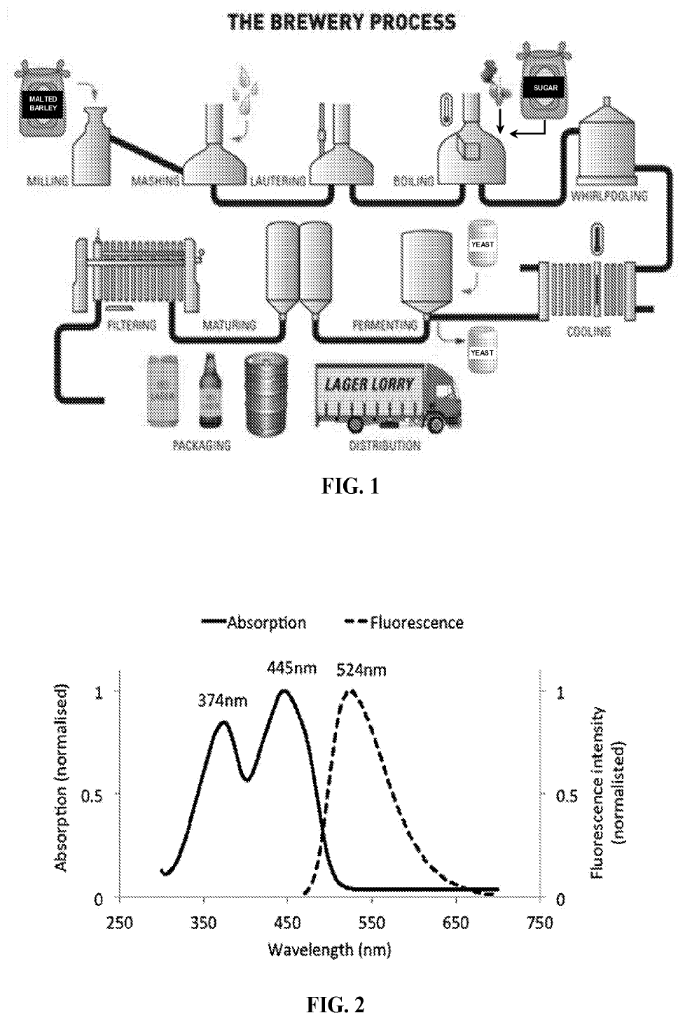

Referring now to FIG. 1, the typical process for brewing beer includes the following steps: malting, milling, mashing, boiling/brewing, cooling, fermenting, conditioning, filtering and racking (chem409.wikispaces.com). Malting is the process of preparing the grain for brewing. During the malting step, the grains are germinated by soaking in water, and are then halted from further germinating by drying with hot air in a kiln (also known as kilning). Malting grains develops the enzymes (e.g., α- and β-amylase) required to break down the grain's starches into simple sugars. Next, the grains are milled, thereby exposing the starch to the enzymes in the mashing process.

Mashing allows the enzymes in the malt to break down the starch in the grain into simple sugars. There are two commonly used mashing methods: (i) infusion mashing, in which the grains are heated in one vessel; and (ii) decoction mashing, in which a proportion of the grains are boiled and then returned to the mash, raising the temperature. At the end of the mashing, the sugar-rich liquid that is strained through the bottom of the mashing tun (also known as lautering) is referred to as wort.

Next, the wort is sent to a brew kettle where it is boiled. During the wort boiling process, hops are added to create the bitterness, flavor and aroma of beer. A number of changes occur in the wort, such as coagulation of protein, evaporation of the wort, and alterations to flavor and color. After brewing, the wort is filtered and quickly cooled to a temperature where the yeast can be safely added (typically between 20° C.-30° C.). During fermentation, the yeast metabolizes the sugar in the wort into ethanol and carbon dioxide. The yeast is allowed to ferment for at least a week and the immature beer is allowed to condition to refine the flavor of the beer.

Often times, the beer is filtered and transferred to a secondary fermentor to reduce off-flavors and allow the beer to condition for a longer period of time in a fresh fermentor. After conditioning, if a clear beer is desired, it can be filtered, cold crashed, and/or combined with clarifying agents to further clarify the beer. Exemplary clarifying agents, include, but are not limited to, biofine, gelatin, irish moss, WHIRFLOC®, chitosan, kieselsol, Super-Kleer KC and White Lab's clarity ferm. Some products such as WHIRFLOC® and clarity ferm can also be used in earlier stages of the brewing process (e.g., added to the wort before fermentation). Finally, the beer is carbonated or nitrogenized and ready to be served.

Contrary to the above known brewing process, the present invention provides for the addition of powdered riboflavin or a saturated riboflavin solution (i.e., powdered riboflavin dissolved in water) to the brewing process, thereby producing a beer saturated with riboflavin such that the resulting beer takes on the spectral properties of riboflavin. In various embodiments, the riboflavin is added after boiling when the wort is warm and the riboflavin can easily be solubilized. In various embodiments, the riboflavin is added during the maturation stage, right before filtration. However, as one of skill in the art would understand, the riboflavin may be added at any stage of the process that is convenient since riboflavin is heat-stable. As such, the riboflavin may be added before, during and/or after the boil, and/or before or after carbonation or nitrogenation.

The solubility of riboflavin in water is about 0.1-0.13 mg/ml at room temperature. At warmer temperatures its solubility may be increased even further as riboflavin is relatively heat stable, thereby creating a super-saturated composition. However, solubility of riboflavin drops to about 0.045 mg/ml in absolute ethanol further complicating the art of making alcoholic beverage glow utilizing this agent. Additionally, Riboflavin is stable in acidic conditions and in the presence of oxidizing agents, but is very sensitive to alkaline conditions and to light. Thus, one of skill in the art would appreciate that treating a beverage with a riboflavin solution should be performed while protecting the beverage from light (for more information on the properties of riboflavin, see pubchem.ncbi.nlm.nih.gov/compound/riboflavin#section=Top, incorporated herein by reference). As such, in various embodiments, the amount of riboflavin to be added may be in excess of 0.17 mg/ml. In various embodiments, the amount of riboflavin to be added may be less than or equal to 0.13 mg/ml. Thus, the final concentration of riboflavin in the beverage may be about 0.005-0.17 mg/ml. In various embodiments, the final concentration of riboflavin in the beverage is about 0.033 mg/ml-0.0125 mg/ml.

Accordingly, in another aspect, the invention provides an effervescent beverage (e.g., beer) containing a saturating concentration of riboflavin such that the beverage takes on the spectral properties of riboflavin.

### Spectral Properties of Riboflavin and Black Light Emission

The absorption spectrum for riboflavin is shown in FIG. 2. Maximal absorption of riboflavin is at 445 nm (with a secondary peak at 371 nm). Most black lights emit at 370 nm, thus resulting in the bright yellow fluorescence observed for riboflavin solution as demonstrated in Examples 1-6. However, in various embodiments, a light source that emits at 445 nm may be used to irradiate the riboflavin-infused beer.

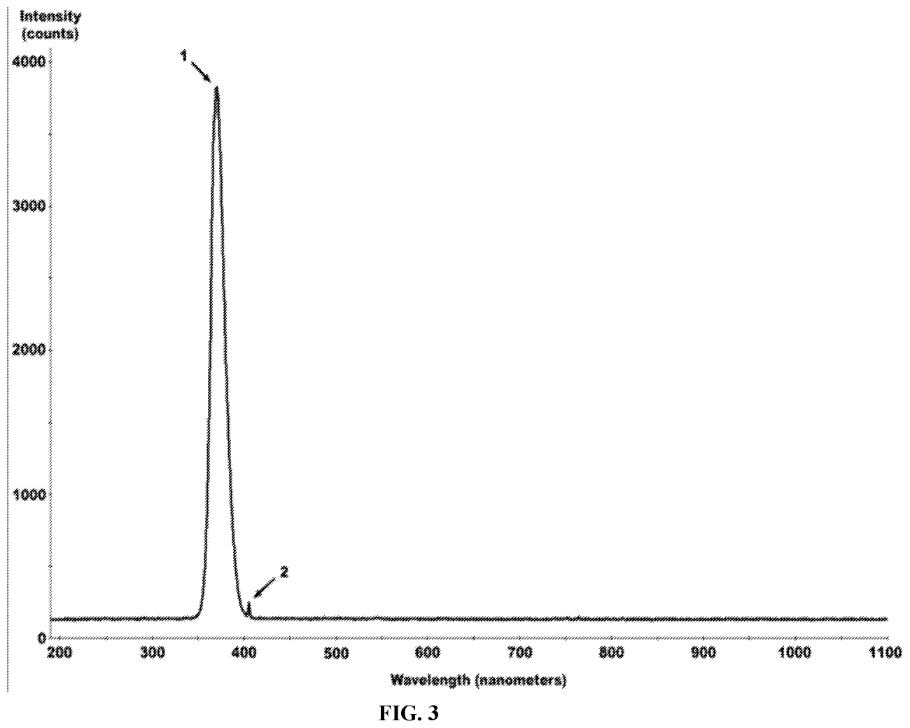

Full width at half maximum (FWHM) spectral bandwidth of the 370 nm peak is about 20 nm. As used herein, “full width at half maximum” or “FWHM” refers to an expression of the extent of a function given by the difference between the two extreme values of the independent variable at which the dependent variable is equal to half of its maximum value. In other words, it is the width of a spectrum curve measured between those points on the y-axis which are half the maximum amplitude. As shown in FIG. 3, the tiny secondary peak (2) is light from the mercury vapor line at 404 nm leaking through the filter, which gives the lamp its purple glow (see, en.wikipedia.org/wiki/Blacklight, incorporated herein by reference).

In various embodiments, the beer is exposed to light having an emission of about 100 nm-500 nm. However, the emission of the fluorescence would be more intense and visually appealing if the riboflavin solution was exposed to a light that corresponded to its maximal absorption peak (i.e., a black light with maximal emission at 445 nm).

### Additional Agents

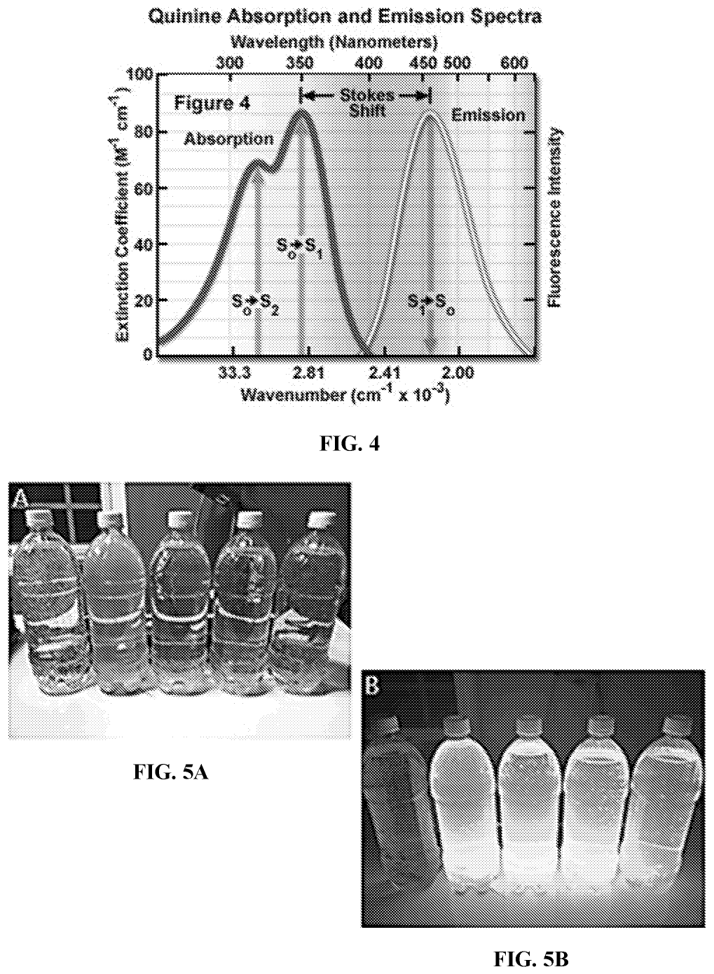

Quinine is a flavor component of tonic water and bitter lemon drink mixers that is known to have an ultraviolet absorption peak of around 350 nm (see FIG. 4), with a fluorescent emission peak at around 460 nm (i.e., bright blue/cyan hue). In this case since the quinine emits a blue color the beer would look green. The appeal and intensity of the glow can be increased by combining quinine and riboflavin. Other natural blue pigments that are interchangeable for quinine are phyocyanin and phycocyanobilin. Thus, in various embodiments, other natural compounds that fluoresce strongly may be used alone or in combination with riboflavin. For example, vitamin A, thiamine (vitamin B1), pyridoxine/pyridoxal phosphate (vitamin B6), niacin (vitamin B3), folate/folic acid (vitamin B9), biotin (vitamin H), vitamin C and cobalamin vitamin B12 are compounds that may be used alone or in combination with riboflavin to produce a beer that fluoresces in ultraviolet light. In various embodiments, bioluminescent compounds, such as green, blue, or red fluorescent proteins (GFP, BFP, RFP, respectively) or luciferase may be used as an additive to adjust color and/or intensity of the resulting beer.

In various embodiments, one or more flavorings may be added to the beverage to counter any negative flavor resulting from the addition of riboflavin. Exemplary flavorings include, but are not limited to, extracts of passion fruit, guava, orange, grape, coconut, citrus, pineapple, melon, watermelon and lemon. Such extracts may be added in liquid or paste form. Additional flavorings include, but are not limited to, honey, vanilla, coffee, wood chips, bourbon, maple syrup and several hop varieties including but not limited to AMARILLO®, Cascade, Centennial, Chinook, Willamette, Saaz, Perle, Magnum, Nugget and MOSAIC®.

The following examples are intended to illustrate but not limit the invention.

### EXAMPLE 1

### Addition of a Solid Phase Glowing Agent To 5% Ethanol

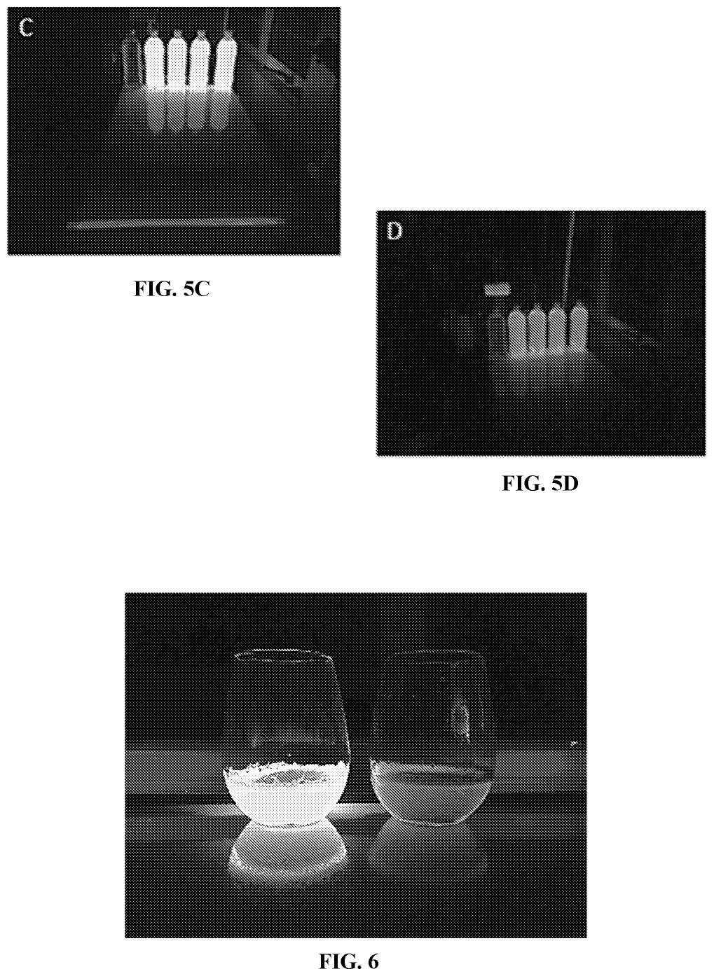

The solubility of riboflavin is 0.1-0.13 mg/ml in water and 0.045 mg/ml in absolute ethanol according to Pubchem Open Chemistry database. To determine the most suitable concentration of riboflavin to use to make beer glow in the dark a range of riboflavin concentrations (0.15 mg/ml, 0.033 mg/ml, 0.025 mg/ml and 0.0125 mg/ml) were tested in a 5% alcohol solution. Riboflavin solutions were made by adding the appropriate amount of solid riboflavin to one liter of 5% ethanol. All test samples emitted a bright yellow fluorescence (FIGS. 5A-5D) when exposed to black light (˜370 nm). The higher concentrations resulted in some riboflavin settling, while hardly any settling was appreciated for the lower concentrations. Final riboflavin concentrations, for all panels, from left to right: negative control, 0.15 mg/ml, 0.033 mg/ml, 0.025 mg/ml and 0.0125 mg/ml. The UV light source was placed directly against the bottles (FIG. 5B), 3 feet away (FIG. 5C) and 8 feet away (FIG. 5D).

### EXAMPLE 2

### Addition of Glowing Agent Prior to Carbonation

A 5 gallon batch of beer was brewed utilizing 7 lbs DME Briess Pilsen light, 2 lbs amarillo hops at 15 and 16 min, and a pilsner lager yeast strain following protocols described in The New Complete Joy of Home Brewing (Charlie Papazian, Avon Books, NY, second edition 1991, incorporated herein by reference). Irish moss was added as a clarifying agent. After primary fermentation for ˜1 week, the beer was filtered and transferred to a secondary fermentor. After a few days ˜400 ml of beer were removed from the fermentor. Riboflavin was added in excess (˜25 mg) to half of the beer (˜200 ml) to produce a riboflavin saturated beer solution, the other half was left untreated to serve as a negative control. To make sure that the solution was saturated with riboflavin, the beer was heated to ˜75° C. After the beer cooled to room temperature, it was filtered to remove excess unsolubilized riboflavin and carbonated with CO₂. The resulting beer treated with riboflavin glowed intensely when exposed to a black light, while the untreated control did not (FIG. 6).

### EXAMPLE 3

### Addition of Glowing Agent After Carbonation

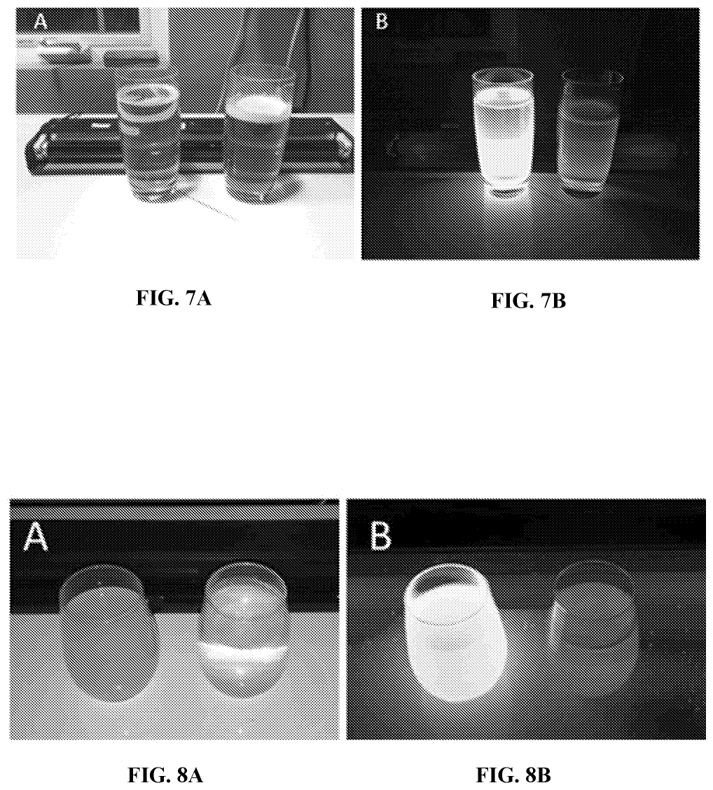

A 0.1 mg/ml riboflavin liquid solution was prepared in water. 43.75 ml of the stock solution was added to approximately 12 ounces (350 ml) of TECATE® Light in a clear glass. No fizziness was observed as a result of addition of the riboflavin (as opposed to when solid riboflavin is added to a carbonated drink) and the resulting mixture was homogenous and analyzed under a black light. The resulting beer emitted bright yellow light when exposed to black light while the negative control (TECATE® Light without riboflavin) did not (FIGS. 7A and 7B).

### EXAMPLE 4

### Addition of Glowing Agent in Water

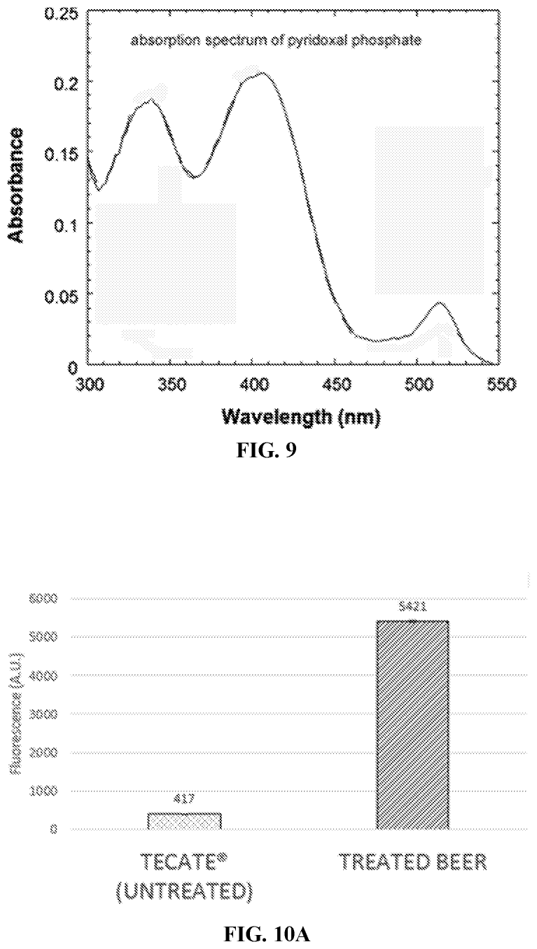

50 mg of pyridoxal-5-phosphate and 500 mg of pantothenic acid were added to approximately 150 ml of water. The solution containing pyridoxal phosphate emitted a bright yellow fluorescence under black light, while the pantothenic acid solution did not (FIG. 8). FIG. 9 shows that the active form of vitamin B6, pyridoxal-5-phosphate, has a strong absorbance at 340 nm and 410 nm.

### EXAMPLE 5

### Large-Scale Production of a Fluorescent Beer

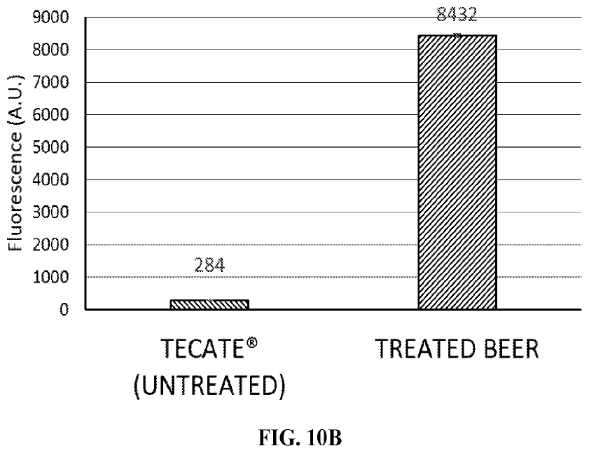

65 g of riboflavin were added to a 155-gallon maturation tank containing 500 L (132 gallons) of recently fermented pilsner. To counterbalance any potential bitter flavor resulting from addition of riboflavin, 2.5 kg of passion fruit paste was added to the mixture. The blend of ingredients was properly mixed and allowed to sit for a week. This resulted in a beer solution containing ˜0.13 mg/ml riboflavin. Biofine was used as a clarifying agent. The resulting clarified beer was carbonated and transferred to 5-gallon stainless steel kegs and analyzed for taste and brightness. The clarified beer had good flavor and was approximately 30 times brighter than an untreated TECATE® beer when both were exposed to 445 nm wavelength UV light (FIGS. 10A and 10B), which corresponds to the maximal absorption of riboflavin (see FIG. 2). Fluorescence of the treated beer was also tested at riboflavin's secondary peak of absorption, 374 nm. Compared to untreated TECATE® beer, the treated beer was approximately 13 times brighter when exposed to light of wavelength 374 nm.

### EXAMPLE 6

### Changing the Color Profile of Fluorescent Beer

To alter the color profile of a treated beer, the natural blue colorant phycocyanin was added to the treated beer prepared in Example 5 at a concentration of 0.5 mg/ml. The resulting beer was green in appearance and still emitted a strong fluorescence at 524 nm, as determined visually under black light and by spectrophotometry at excitation 374 nm and 445 nm.

Although the invention has been described with reference to the above example, it will be understood that modifications and variations are encompassed within the spirit and scope of the invention. Accordingly, the invention is limited only by the following claims.

What is claimed is:

1. A fluorescent beer comprising 0.005-0.17 mg/ml of riboflavin content.

2. The fluorescent beer of claim 1, wherein the beer has about 0.05 mg/ml to 0.13 mg/ml of riboflavin content.

3. The fluorescent beer of claim 1, wherein the beer fluoresces when exposed to light having an emission spectrum of about 100-500 nm.

4. The fluorescent beer of claim 3, wherein the beer fluoresces when exposed to light having an emission spectrum of about 350-475 nm.

5. The fluorescent beer of claim 4, wherein the beer fluoresces when exposed to light having an emission spectrum of about 445 nm.

6. The fluorescent beer of any one of claims 1-5, further comprising one or more agents selected from the group consisting of vitamin A, thiamine (vitamin B1), vitamin B2, pyridoxine/pyridoxal phosphate (vitamin B6), niacin (vitamin B3), folate/folic acid (vitamin B9), vitamin B12, biotin (vitamin H), vitamin C, quinine, phycocyanin, and phycocyanobilin.

7. The fluorescent beer of any one of claims 1-6, further comprising one or more bioluminescent compounds selected from the group consisting of green fluorescent protein, blue fluorescent protein, red fluorescent protein, and luciferase.

8. The fluorescent beer of any one of claims 1-7, further comprising one or more flavoring agents selected from the group consisting of extract of passion fruit, extract of guava, extract of orange, extract of grape, extract of coconut, extract of citrus, extract of pineapple, extract of melon, extract of watermelon and extract of lemon.

9. The fluorescent beer of any one of claims 1-8, further comprising honey, vanilla extract, coffee, bourbon, or maple syrup.

10. A method for producing a fluorescent effervescent beverage comprising mixing a fluorescent agent with an effervescent beverage and exposing the mixture to a light having an emission spectrum of about 100-500 nm, thereby producing a fluorescent effervescent beverage.

11. The method of claim 10, wherein the effervescent beverage is beer.

12. The method of claim 10, wherein the fluorescent agent is riboflavin.

13. The method of claim 12, wherein the beverage is further mixed with one or more agents selected from the group consisting of vitamin A, thiamine (vitamin B1), vitamin B2, pyridoxine/pyridoxal phosphate (vitamin B6), niacin (vitamin B3), folate/folic acid (vitamin B9), vitamin B12, biotin (vitamin H), vitamin C, quinine, phycocyanin, and phycocyanobilin.

14. The method of any one of claims 10-13, wherein the beverage is further mixed with one or more bioluminescent compounds selected from the group consisting of green fluorescent protein, blue fluorescent protein, red fluorescent protein, and luciferase.

15. The method of claim 12, wherein the mixture has about 0.05 mg/ml to 0.13 mg/ml of riboflavin content.

16. The method of claim 15, wherein the light has an emission spectrum of about 350-475 nm.

17. The method of claim 16, wherein the light has an emission spectrum of about 445 nm.

18. The method of claim 12, wherein the beverage is further mixed with one or more flavoring agents selected from the group consisting of honey, vanilla extract, coffee, bourbon, or maple syrup extract of passion fruit, extract of guava, extract of orange, extract of grape, extract of coconut, extract of citrus, extract of pineapple, extract of melon, extract of watermelon and extract of lemon.

19. A method for producing a fluorescent beer comprising adding riboflavin to a wort of a beer brewing process; fermenting the mixture to produce ethanol and carbon dioxide from the wort; and producing a beer having about 0.005-0.17 mg/ml of riboflavin content.

20. The method of claim 19, wherein the beer has about 0.0125 mg/ml-0.033 mg/ml of riboflavin content.

21. The method of claim 19, wherein riboflavin in excess of 0.17 mg/ml is added to the wort.

22. The method of claim 19, wherein the riboflavin is added before, during or after boiling of the wort.

23. The method of claim 19, wherein the riboflavin is added before, during or after fermentation.

24. The method of claim 19, wherein the riboflavin is added before or after carbonation or nitrogenation of the beer.

25. The method of any one of claims 19-24, wherein the riboflavin is added in combination with one or more agents selected from the group consisting of vitamin A, thiamine (vitamin B1), vitamin B2, pyridoxine/pyridoxal phosphate (vitamin B6), niacin (vitamin B3), folate/folic acid (vitamin B9), vitamin B12, biotin (vitamin H), vitamin C, quinine, phycocyanin, and phycocyanobilin.

26. The method of any one of claims 19-24, wherein the riboflavin is added in combination with one or more bioluminescent compounds selected from the group consisting of green fluorescent protein, blue fluorescent protein, red fluorescent protein, and luciferase.

27. The method of any one of claims 19-24, wherein the riboflavin is added in combination with one or more flavoring agents selected from the group consisting of honey, vanilla extract, coffee, bourbon, or maple syrup extract of passion fruit, extract of guava, extract of orange, extract of grape, extract of coconut, extract of citrus, extract of pineapple, extract of melon, extract of watermelon and extract of lemon.
